(19) United States
(12) Patent Application Publication
(10) Pub. No.: US 2020/0020178 A1
(43) Pub. Date: Jan. 16, 2020

(54) Method and System for Determining the Expected Useful Life of Electrical Apparatus

(71) Applicant: Siemens Aktiengesellschaft, München (DE)

(72) Inventors: Wiebke Fröhner, Amberg (DE); Ivana Mladenovic, Seukendorf (DE); Thomas Werner, Rednitzhembach (DE)

(73) Assignee: Siemens Aktiengesellschaft, München (DE)

(21) Appl. No.: 16/491,341

(22) PCT Filed: Feb. 15, 2018
(86) PCT No.: PCT/EP2018/053749

§ 371 Date: Sep. 5, 2019

(30) Foreign Application Priority Data
Mar. 8, 2017 (DE) 10 2017 203 836.5

(51) Int. Cl. G07C 3/02; G06N 3/08

(52) U.S. Cl. CPC G07C 3/02; G06N 3/08

(57) ABSTRACT

Various embodiments include a method for determining an expected service life of an electrical apparatus with respect to a reference time comprising: providing an ageing model describing an ageing behavior of the apparatus; recording a value of an electrical operating parameter of the apparatus during operation of the apparatus; adjusting the ageing model based at least in part on the recorded value; and determining the expected service life of the apparatus using the adjusted ageing model.

### CROSS-REFERENCE TO RELATED APPLICATIONS

This application is a U.S. National Stage Application of International Application No. PCT/EP2018/053749 filed Feb. 15, 2018, which designates the United States of America, and claims priority to DE Application No. 10 2017 203 836.5 filed Mar. 8, 2017, the contents of which are hereby incorporated by reference in their entirety.

### TECHNICAL FIELD

The present disclosure relates to electrical apparatus. Various embodiments may include methods and/or systems for determining an expected service life of an electrical apparatus with respect to a reference time.

### BACKGROUND

Electrical apparatuses are subject to ageing and therefore have a limited service life or life expectancy. If the particular life expectancy of an apparatus is not known, then there may be provision for example to exchange the apparatus in accordance with a set schedule, or the apparatus may be operated until the actual end of its service life and exchanged only when it fails. In the former case, this results in an unnecessarily high material, servicing, and cost expenditure, whereas, in the latter case, a reliability and availability of a device or of a system in which the apparatus is incorporated drops.

In order to avoid an unnecessarily early exchange of the apparatus, known diagnostic methods may be used to determine a current actual state of the apparatus on a regular basis and this determined actual state may be used to decide whether or not the apparatus is exchanged. Such diagnostic methods are normally applied offline, when the apparatus is in the switched-off state. As a result, however, the availability and/or the efficiency of the apparatus or of the operation thereof may be reduced. For some apparatus, the actual state may be determined for example by way of a diagnosis, performed during operation of the apparatus, in the form of a partial discharge measurement. Such a partial discharge measurement however delivers only information about possible local weak points, whereas possible failures for example of the apparatus due to thermal ageing are detected too late or even not detected at all. In addition, specific and complex measurement devices are required for the known diagnostic methods, independently of whether or not these are able to be applied during operation of the apparatus.

Furthermore, there are ageing models for some apparatuses or components thereof that are able to make predictions with regard to an expected service life of the apparatus in precisely defined standard conditions. Overall, therefore, the previously known and available methods for determining an expected service life or remaining service life of electrical apparatuses are generally connected with a high expenditure in terms of apparatus and personnel, that is to say are thus complex and expensive, and/or unhelpful or unreliable.

### SUMMARY

The object of the present invention is to allow improved determination of a remaining service life of an electrical apparatus that has already been put into operation. For example, some embodiments may include a method (1) for determining an expected service life (14) of an electrical apparatus (21, 22, 23, 24) with respect to a reference time (7, 8, 10), characterized by providing an ageing model (2) that describes an ageing behavior of the apparatus (21, 22, 23, 24), recording a value (3) of at least one electrical operating parameter of the apparatus (21, 22, 23, 24) during operation of the apparatus (21, 22, 23, 24), adjusting the ageing model (2) depending on the recorded value (3), and determining the expected service life (14) of the apparatus (21, 22, 23, 24) on the basis of the adjusted ageing model.

In some embodiments, a subfunction (4) of the ageing model (2) is additionally weighted in order to adjust the ageing model (2).

In some embodiments, the subfunction (2) is weighted (5) depending on a type of the reference time (7, 8, 10) and/or on a loading history (11) of the apparatus (21, 22, 23, 24) and/or on an environmental state (12) and/or on a number of errors (12) that have occurred on the apparatus.

In some embodiments, a loading forecast (13) of the apparatus (21, 22, 23, 24) is provided, and the ageing model (2) is additionally adjusted depending on the loading forecast (13).

In some embodiments, the value (3) of the operating parameter is recorded by way of active management of an electrical grid into which the apparatus (21, 22, 23, 24) is incorporated and/or of a device serving for error detection purposes.

In some embodiments, the expected service life (14) is determined in a recursive and self-learning process, wherein the reference time (8, 10) is automatically redefined depending on a loading of the apparatus (21, 22, 23, 24) and/or on the determination (1) of the expected service life (14), and/or a loading forecast (13) of the apparatus (21, 22, 23, 24) is automatically adjusted on the basis of previous recorded values (3) of the operating parameter.

In some embodiments, the determined expected service life (14) at a current determination time is compared with a remaining service life derived for this determination time from at least one previous determination (1) of the expected service life (14).

In some embodiments, in the case of an apparatus (21, 22, 23, 24) formed from an assembly of a plurality of elements, the respective expected service life (14) for each of the elements is first of all determined, and the expected service life (14) of the overall apparatus (21, 22, 23, 24) is then determined as the lowest of the expected service lives (14) of the individual elements.

In some embodiments, the ageing model is adjusted continuously or regularly during operation of the apparatus, in particular at predefined time periods, depending on a plurality, in particular all, of the values recorded up to a respective current time.

In some embodiments, the determined expected service life (14) is transmitted to a control device (25), which then controls operation of a device (20) comprising the apparatus (21, 22, 23, 24) depending on the expected service life (14).

As another example, some embodiments include a system for determining (1) an expected service life (14) of an electrical apparatus (21, 22, 23, 24) with respect to a reference time (7, 8, 10), wherein the system comprises a recording device for recording a value (3) of at least one electrical operating parameter of the apparatus (21, 22, 23, 24) during operation of the apparatus (21, 22, 23, 24), and a storage device storing an ageing model (2) that describes an ageing behavior of the apparatus (21, 22, 23, 24), and a data processing device for adjusting the ageing model (2) depending on the recorded value (3) of the operating parameter and for determining the expected service life (14) of the apparatus (21, 22, 23, 24) on the basis of the adjusted ageing model.

### BRIEF DESCRIPTION OF THE DRAWINGS

Further features, details, and advantages of various embodiments of the teachings of the present disclosure become apparent from the following description of exemplary embodiments and with reference to the drawings, in which:

FIG. 1 shows a schematic illustration of a method for determining an expected service life of an electrical apparatus incorporating teachings of the present disclosure; and

FIG. 2 shows a schematic and sectional illustration of an electrical grid in which the expected service lives of a plurality of individual apparatuses are monitored.

### DETAILED DESCRIPTION

Some embodiments of the teachings herein include a method for determining an expected service life of an electrical apparatus with respect to a reference time—that is to say for determining a remaining service life of the apparatus—an ageing model is first of all provided that describes an ageing behavior of the apparatus, in particular depending on at least one electrical operating parameter of the apparatus. Furthermore, at least one value of the at least one electrical operating parameter of the apparatus is recorded during operation of the apparatus. The ageing model is then adjusted depending on the recorded value of the electrical operating parameter. In other words, the ageing model may be tested using or taking into account the recorded values or data and adjusted where necessary. Finally, the expected service life of the apparatus is determined on the basis of the adjusted ageing model.

An electrical apparatus within the meaning of the present disclosure may be for example an electrical component, a module, and/or a unit in an electrical installation. The electrical apparatus may thus be an object that serves, as a whole or in some parts, to apply electric power or to transmit, distribute and process information. Electrical protection means and/or auxiliary means may also be electrical apparatus within the meaning of the present disclosure. Examples of electrical apparatus, without restricting the scope of the present disclosure thereto, may comprise for instance electrical grids or parts thereof, transformer stations or individual transformers, node points, cables and lines, switches or relays, resistors, transistors, regulators, power components, drive components, such as for example an electric motor or parts thereof, and more of the like.

The actual service life of the apparatus with respect to a reference time specifies that time or time interval that runs from the reference time to a future time at which the apparatus no longer meets a respective requirement placed thereon due to an age-induced or ageing-induced state of the apparatus. This may be the case for example when the apparatus fails or breaks down in part or in full. The apparatus may however likewise have already reached an end of its service life when, although it is still functional in principle, it is functional for example only with limited capability or efficiency that no longer lies for example above a predefined threshold value. The expected service life is a calculated, forecast, and/or estimated value of the service life that thus does not have to match the actual service life that ultimately arises.

In many areas, in particular in electrical transportation and distribution grids, loadings and loading profiles of apparatus, that is to say in particular of grid components, have changed considerably in recent years. In particular, volatility or fluctuation of the loads has increased significantly, for example due to increasing integration or infeed of renewable energies. This has significant effects on the ageing behavior of the apparatus, such that previously used and sufficient typical loadings, load curves, and corresponding ageing models no longer apply, or apply only to a limited extent. Accordingly, reliable determination of the expected service lives of the apparatus that are used is increasingly necessary and advantageous for state-oriented asset management and maintenance planning.

The reference time may be for example a time of manufacture, of putting into service, of an—in particular last performed—diagnostic measurement in order to determine the actual state of the apparatus or a time—in particular a last time—at which the expected service life was determined. Thus, for example, the expected service life may be determined depending on an and/or based on an actual state or ageing state of the apparatus that has been determined by way of a previous determination and/or a previous diagnostic measurement. This actual or ageing state may thus serve as a reference value for the currently determined expected service life or a change in the expected service life in comparison with this reference value or as an expected service life determined at the reference time.

The electrical operating parameter may be for example a current intensity of an electric current flowing through the apparatus and/or switched by the apparatus and/or an electric voltage applied to the apparatus or switched by the apparatus. Likewise, however, other variables, such as for example an electrical resistance, an electric power, an electric power loss, occurring in particular at the apparatus, or more of the like may be used as the electrical operating parameter, that is to say recorded. These variables may be recorded and/or measured using known means, such as for example appropriate sensors and/or taps arranged on the respective apparatus, and with little material and cost expenditure, including during operation of the apparatus.

The recording or measurement of the electrical operating parameter or of its value may be performed continuously or regularly, for example at predetermined time periods or intervals and/or upon certain events, such as for example switching-on or putting into service and/or upon reaching or exceeding a predefined threshold value for the operating parameter. A continuous measurement in this case offers the advantage of comprehensive recording, which thus allows increased reliability and accuracy of the determined expected service life. A recording or measurement at regular time periods by contrast offers a lower data volume that is thus easier to process of respective recorded or measured values or data.

The ageing model may comprise one or more functions and/or subfunctions that may adopt and process one or more input variables as arguments. The output of the ageing model includes the expected service life, for example in the form of a time interval or of a time, as a result or output variable. The time interval may in this case specify a remaining operating time of the apparatus, after the expiry of which the apparatus provisionally, in particular under defined or predefined assumptions or operating conditions, reaches the end of its service life. The ageing model may likewise comprise for example one or more characteristic curves and/or characteristic diagrams that are able to specify for example relationships between the one or more electrical operating parameters and an ageing or an ageing behavior of the apparatus. In some embodiments, the ageing or service life model may comprise at least one in particular self-learning neural network that is trained for example using measured data of the apparatus and/or of one or more corresponding similar or comparable apparatuses.

The ageing model may take into account thermal and electrical influences that contribute to the ageing of the apparatus. To depict or model thermal ageing, it is possible for example to apply the Arrhenius law, also called Arrhenius equation, as part of the ageing model. An electrical ageing of the apparatus may be depicted or modeled for example by way of a corresponding inverse power law. In some embodiments, switching procedures or a number of switching procedures of the apparatus may be taken into account in the ageing model. These may be recorded for example by way of a counter. Taking into account switching procedures may be advantageous since, as a result, wear of the apparatus is able to be incorporated. Some apparatus are only able to perform or execute a limited number of switching procedures before they have reached the end of their service life. In this case, this number may depend on further conditions, such as for instance an electrical and/or thermal loading, in particular during the switching procedures. A weight may therefore be assigned to each switching procedure taken into account in the ageing model, depending on at least one further operating parameter and/or at least one environmental condition, in particular of the apparatus, during the respective switching procedure.

In some embodiments, to determine the expected service life, the reference time may be predefined and then used as input variable for the ageing model. The ageing model may be adjusted for example by replacing a standard value or a nominal condition in a known ageing model with the recorded value of the electrical operating parameter of the apparatus. Likewise, adjusting the ageing model may mean that the recorded value, in particular the respective last recorded value, is inserted into the ageing model. The expected service life determined by way of the ageing model is thus updated. This updating or recalculation of the expected service life may be performed continuously, that is to say in particular as soon as a new value of the operating parameter is recorded. Adjusting the ageing model may thus be, mean and/or comprise implementing or computing the ageing model with the recorded value. The recorded value may in this case be the actual measured value, but it is also possible to use, in addition or as an alternative, a multiplicity of measured values and/or a variable derived therefrom, such as for example an average value, a maximum value, a gradient of the operating parameter or more of the like. By adjusting the ageing model in this way, that is to say individually and according to the situation, describes the actual ageing behavior of the individual apparatus under the respective actually present or occurring loadings or operating conditions.

The expected service life of the apparatus may be determined on the basis of the ageing model adjusted in this way for example by solving or calculating the ageing model, for example by way of a data processing device. The data processing device may to this end for example comprise a processor device and a storage device. The storage device, may store a program code that represents or codes the method steps of at least one embodiment of a method described herein, which program code is thus configured so as to perform the method when it is executed by the data processing device or the processor device thereof.

Where necessary or provided in the ageing model that is used, one or more input variables for determining the expected service life may be predefined or input, for example predefined by an operator, for example via a corresponding input or operating mask or interface of the data processing device. In some embodiments, the data processing device to read some or all of the input variables independently or automatically, or to retrieve them for example from a database device or from the storage device. It is likewise possible for the apparatus to comprise a storage device or identifier and possibly a corresponding interface, by way of which it is made possible to transmit data or properties of the individual apparatus that are able to be used as input variables for the ageing model.

By way of example, a QR code and/or barcode may be arranged on the apparatus, which QR code or barcode codes data and/or properties of the apparatus that are relevant to determining the expected service life or to the ageing model. This code may be read for example when the apparatus is installed or put into service, as a result of which the coded data are provided, that is to say in particular transmitted, to the data processing device. The data or properties of the apparatus may comprise for example a cable type or parameter, a material, a specification, in particular with regard to an interval of values intended for correct operation, in particular of the operating parameter, and/or a design of the apparatus or more of the like.

In some embodiments, the apparatus does not have to be switched off or disconnected in order to determine its expected service life or remaining service life, and the determined expected service life takes into account the actual situation and loading of the individual apparatus and is thus particularly accurate, reliable and helpful. The expected service life is able to be determined with particularly low material, personnel, measurement, and cost expenditure, since the electrical operating parameter serving as a basis may be recorded easily and is recorded during the operation of the apparatus.

In some embodiments, at least one limit or threshold value for the expected service life may be predefined. After determining the expected service life, this may then be compared with the predefined limit or threshold value. If the determined expected service life falls below the limit or threshold value, then a notification or a warning may be generated. In some embodiments, a plurality of limit or threshold values, with which the determined expected service life is compared, may be predefined. Depending on the result of this comparison, a warning notification may then be output to an operator, for example using a color-coded display, for instance a traffic light display.

In some embodiments, the determined expected service life or a value of the determined expected service life may be generated for example to a further data processing device or a further data processing system, for example an asset management system. It is likewise possible to automatically generate a report on the basis of the variables processed in the method according to the invention and/or the expected service life determined therefrom, which report may then likewise be sent automatically, for example by email.

The teachings of the present disclosure may be applied not just to electrical grids or power grids, but also for example in the context of what is known as Industry 4.0, and in general anywhere where electrical operating parameters or electrical apparatus are or are able to be recorded or monitored.

In some embodiments, a subfunction of the ageing model is additionally weighted in order to adjust the ageing model. In other words, a weighting factor may thus be inserted into the ageing model and/or a weighting factor provided or present as part of the ageing model may be adjusted, that is to say varied or changed. As a result, the ageing model may be adjusted to the individual apparatus and/or its individual situation, in particular an individual loading or an individual loading profile. Improved accuracy and reliability of the determined expected service life is accordingly able to be achieved. The subfunction may be weighted for example depending on a type of the reference time and/or on a loading history of the apparatus and/or on an environmental state of an environment of the apparatus and/or on a number of errors that have occurred on the apparatus. To this end, respectively corresponding characteristic curves or characteristic diagrams that allow the ageing model to be automatically adjusted may be predefined.

In other words, the ageing model may thus comprise a combination, for example a linear combination, of subfunctions that each describe a dependency of the service life or of the change in service life or of the ageing behavior of the apparatus on a specific influencing variable, for example the voltage or the temperature. Some or all of these subfunctions may then comprise a weighting factor or be multiplied by a weighting factor.

The type of reference time may in this case for example specify whether the reference time is a time of manufacture, of putting into service or for instance of a performed measurement or determination of the expected service life. In this case, a plurality of different reference times may be taken into account. By way of example, a weighting factor that characterizes an influence of an environmental temperature on the expected service life may be changed or be selected so as to be different depending on whether the reference time is a manufacturing time or a time of putting into service. As a result, it is advantageously able to be taken into account for example that the environmental temperature influences the ageing behavior or the expected service life of the apparatus to a differing extent depending on whether or not the apparatus is operating or for example is initially stored following the manufacturing time until being put into service, that is to say is not operating or has not been operated.

A specification of the apparatus may likewise for example be taken into account. By way of example, operation of the apparatus in an environment whose temperature, humidity, pH value, vibration behavior or the like lies outside of a recommended operating condition may be taken into account by adjusting or selecting corresponding weighting factors for these variables. Thus, by way of example, operation of the apparatus at an environmental temperature lying outside of the recommended specification may lead to disproportionately great thermal ageing of the apparatus, which is then taken into account for example by a greater or increased weighting factor for the temperature. Such operating times during previous operation and/or for example loading fluctuations and/or loading peaks that have occurred in the past and that are able to be determined using the load history may also for example influence the ageing behavior and thus the expected service life of the apparatus in a disproportionate or non-linear manner. Such effects are thus preferably taken into account in the adjusted ageing model by correspondingly weighting the at least one subfunction of the ageing model by way of which the corresponding aspect or influence is described.

By adjusting the ageing model, a change in service life or a change in the expected service life or a deviation in the expected ageing behavior of the apparatus is thus able to be described or taken into account with respect to a reference value or reference model, for example a conventional ageing model, that describes the ageing of the apparatus under nominal conditions.

In some embodiments, a loading forecast of the apparatus is provided and the ageing model is additionally adjusted depending on the loading forecast. The loading forecast may for example be created externally and then provided or retrieved in order to perform the described methods. However, it is likewise possible for the loading forecast to be generated automatically on the basis of a loading history of the apparatus, that is to say for example by evaluating values of the operating parameter that were recorded and stored previously, that is to say in the past. A known extrapolation method may for example be used for this purpose. By taking into account the loading forecast, the expected service life may be determined particularly accurately and particularly reliably.

The ageing model may be adjusted depending on the loading forecast for example by weighting a subfunction and/or by adjusting, that is to say changing, at least one weighting factor of the ageing model. By way of example, the loading forecast may predict that there is upcoming operation of the apparatus at a particularly high or low loading, for example an above-average or below-average temperature, current intensity and/or voltage. Corresponding weighting factors that specify an influence of the temperature, of the current intensity or of the voltage on the expected service life may then for example be increased or reduced.

In some embodiments, the value of the operating parameter is recorded by way of active management of an electrical grid into which the apparatus is incorporated and/or a device serving for error detection purposes. In other words, the operating parameter is thus recorded by way of a device that is for example in any case provided in or on the apparatus or is connected thereto. As a result, it is advantageously possible to achieve a dual functionality of this device, and thus improved efficiency. In particular, the expected service life is thus able to be determined without additional material and measurement expenditure.

Such devices for active grid management and/or fast detection of error situations are used in particular in the context of the nowadays increasing digitization of power supply grids, in particular distribution grids. These devices or units, as their primary purpose of use, that is to say active grid management and/or detection of error situations, may for example record currents on lines and/or voltages in grid nodes in order to perform or meet their primary or actual purpose of use. According to the invention, these values or data, that are thus recorded in any case, may be used or utilized to determine the expected service life of the apparatus.

The device by way of which the value of the operating parameter is recorded may comprise a calculation device or unit by way of which the expected service life of the apparatus is determined. A plurality of such devices may thus for example be provided in a grid, an assembly or an installation, by way of which devices the respective expected service lives of different apparatus are then thus determined in a decentralized manner. To this end, for example, firmware of the device or devices may be supplemented by an application reproducing the methods described herein.

To minimize a size of this application or a hardware expenditure required for the device, for example a size or capacity of a storage device, a central computer or server device may be provided. This central server device may be connected to the device or the devices via a data connection or a data network. The central server device may for example comprise a library containing different applications for the various devices and/or containing different ageing models for various apparatus or types of apparatus. There may for example be provision for the respective application and/or the respective ageing model to be transmitted from the central server device to the respective device. This may be performed for example once and initially when an infrastructure comprising the device and the apparatus is installed or when the device and/or the apparatus is put into service.

In this case, further parameters, data and/or properties, in particular for example in relation to the apparatus and/or an environment and/or a loading, may additionally be transmitted to the device. The central server device may additionally offer the advantage that measured values, in particular values of operating parameters and/or environmental conditions, are able to be recorded, stored and/or processed here, in a manner correlated with one another. This thus makes it possible for example to create and/or adjust the ageing model on the basis of a larger data basis. This may in particular be advantageous when the central server device is used by a plurality of operators of apparatus, for example by a plurality of grid operators. In this case, by way of a client-capability-based design of the central server device, a situation is able to be achieved whereby the individual operators only have access to respective data or values of their own apparatuses. Nevertheless, the ageing model that is used may be created and/or adjusted taking into account the values or data of apparatuses of different operators. To this end, for example, the ageing model may be managed, that is to say created, adjusted, updated, provided or the like, by a party different from the operators of the apparatus, for example an operator of the central server device.

The corresponding data may likewise be retrieved and transmitted during operation, that is to say flexibly or when required. In addition to saving on additional hardware, the use of the device that is present in any case for grid management and/or error detection to determine the expected service life is advantageous, as a simpler data transmission infrastructure is thereby able to be used for example, or such a data transmission infrastructure may be dispensed with entirely. By way of example, it is not necessary to transfer any measured or sensed values of the operating parameter from a location of the apparatus to the central server device. Likewise, its expected service life may be displayed advantageously directly in situ, that is to say at the location of the respective apparatus.

In some embodiments, the expected service life is determined in a recursive and self-learning process or method. In this case, the reference time is automatically redefined depending on a loading of the apparatus and/or depending on the determination of the expected service life, that is to say in particular depending on a time of an in particular last determination of the expected service life. In some embodiments, a loading forecast of the apparatus is automatically adjusted on the basis of previously recorded values of the operating parameter.

In some embodiments, the methods may thus be performed recursively and/or iteratively, wherein a time of performance or execution of an iteration step may for example influence the next iteration step, that is to say the next performance of the method, or be used in this iteration step. The expected service life, that is to say the remaining service life of the apparatus that are situated in an area in which the value of the operating parameter is recorded, is thus in each case able to be performed automatically on the basis of the most up-to-date available data without additional measurement expenditure and without interrupting operation. The expected service life and/or corresponding data may be determined and provided particularly accurately, reliably, and punctually, in particular before the expected service life expires. Asset management planning and maintenance planning are thus effectively made possible in real time, or at least virtually in real time, and without interrupting operation, that is to say live.

Specifically, by way of example, a respective time of the respectively last performed determination of the expected service life may be used as reference point for the following determination of the expected service life. Likewise, the values of the operating parameter recorded since the last determination of the expected service life may in each case be used to create the loading forecast taken into account in the subsequent determination of the expected service life. The loading forecast may relate to an overall loading or a residual load.

In particular when uncertain values, such as for example a loading forecast, are also used in addition to specific measured values in the determination of the expected service life, the determination of the expected service life may effectively be an estimate. If a loading forecast is not used, then an average loading or an average loading profile may for example be used as an alternative.

In any case, the expected service life is able to be determined in an increasingly accurate and reliable manner. In this case, respective results of a plurality of iteration steps of the method may advantageously be compared with one another. Thus, for example, a result of an earlier iteration step may be compared, in a later iteration step, with an actual measured value or calculation result that is then present. This may in particular be relevant to and advantageous for the loading forecast. As a result, any deviation that is possibly present is able to be determined by way of a comparison between the forecast and subsequent reality that occurs and used to adjust future forecasts so that these are more accurate and more reliable.

In some embodiments, the determined expected service life at a current determination time is compared with a remaining service life derived for this determination time from at least one previous determination of the expected service life. When or if the expected service life is shorter than the derived remaining service life, a warning notification may then for example be output. In some embodiments, a result of the comparison may be stored for example in a database or the like.

The determination time is in this case a time at which the expected service life is determined. In other words, the expected service life is thus determined for example at a first determination time as remaining service life of the apparatus. A then current expected service life is determined again at a later determination time. The last determined, that is to say determined at the second determination time, expected service life is then compared with the service life or remaining service life predicted in the first determination for the second determination time, that is to say the calculated service life or remaining service life. If the expected remaining service life determined at the second determination time is less than the value predicted at the first determination time for the second determination time, then this means that the life expectancy of the apparatus is decreasing more quickly than calculated or forecast at the first determination time. In other words, the change in service life has thus then occurred or taken place more quickly or to a greater extent than expected. This may be interpreted for example as an indication of an in particular unexpected change in the apparatus, in a loading of the apparatus, in an environmental condition and/or in a device, for example a grid, into which the apparatus is incorporated. The described procedure thus advantageously allows an alternative or assistive or indirect diagnosis of more comprehensive structures or situations.

In some embodiments, the apparatus may be formed from an assembly of a plurality of elements. In such an assembly, the respective expected service life for each of the elements is first of all determined individually. The expected service life of the overall apparatus, that is to say of the whole assembly, may then be determined as the lowest of the expected service lives of the individual elements of the assembly. In other words, the expected service life of the weakest element is thus used as expected service life of the whole assembly. This approach ensures that the whole assembly is able to be kept operational in a particularly reliable manner.

If in this case one of the elements is exchanged due to its life expectancy and replaced by a corresponding new element, then the new element, under some circumstances, has a higher expected service life than another element of the assembly. In this case, in the next determination of the expected service life of the assembly, the expected service life of the other element, which then thus has the shortest expected service life of all of the elements of the assembly, is then thus determined as the expected service life of the whole assembly. The element by way of which the expected service life of the assembly is determined may thus accordingly vary over time.

At the same time, determining the expected service lives of all of the elements allows improved servicing or maintenance planning. In practical cases of application, it may for example be the case that the recorded value of the operating parameter, for example of a current intensity and/or of a voltage, does not describe a single element, but is rather relevant to or characteristic for a plurality of elements. This plurality of elements may then be understood to be an assembly and thus be interpreted as an individual apparatus, in particular including when separate elements, components or modules are actually involved. By way of example, the assembly may be a length of cable that consists of different types of cable and/or of individual cables that were installed in the length of cable at different times and therefore have different expected service lives.

In addition or as an alternative to using the lowest service life of the elements as expected service life of the assembly, a predefined priority list may be used or taken into account to determine the expected service life of the assembly. The priority list may assign for example individual elements respective priorities, for example based on their importance for a basic functionality of the assembly. The element by way of which the expected service life of the assembly is determined may then for example be determined according to priority. By way of such a priority list, it is advantageously possible to individually adjust the determination of the expected service life, by way of which for example specific circumstances may be taken into account, these not being covered or being taken into account in particular by conventional ageing models for complex assembly apparatus.

In some embodiments, the ageing model may be adjusted continuously or regularly during operation of the apparatus, in particular at predefined time periods, depending on a plurality, in particular all, of the values recorded up to a respective current time. There may thus be provision to record the values cumulatively, that is to say not to discard them. By virtue of the automatic continuous or regularly repeated adjustment or updating of the ageing model, a respectively current expected service life is advantageously always known, even in the case of changing operating conditions. In particular, for example, the ageing model may be continuously or regularly adjusted or updated for a specific apparatus, for instance on the basis of analysis or evaluation of the values or data recorded up to the respective time, even during operation of the apparatus. The ageing model—or the ageing models, if a plurality of these are provided or used—for a specific apparatus is thus able to be adjusted continuously during the respective operation by performing data analysis on all of the compiled data. Likewise, other configurations of the method may also be repeatedly performed or applied continuously or regularly, in particular at predefined time periods.

In some embodiments, the determined expected service life of the apparatus is transmitted to a control device, which then controls operation of a device comprising the apparatus depending on the expected service life. In other words, the remaining service life of the apparatus may thus be used as a criterion for example for load control, in particular of an electrical grid. As a result, the load or loading of a plurality of apparatuses may be controlled for example such that ageing that is as uniform as possible of the various apparatuses is achieved. As a result, a servicing and maintenance expenditure of an overall device may be minimized, since all of the apparatus are for example able to be exchanged at the same time. An availability of the overall device may be improved, since it does not need to be switched off in order to exchange each individual apparatus at different times, that is to say does not need to be switched off several times per overall renewal cycle of the apparatus.

In some embodiments, it may likewise be possible to control the load or loading of a plurality of apparatuses in accordance with other criteria or in another way, such that it is thus not necessarily necessary to achieve ageing that is as uniform as possible by controlling the operation. By way of example, there may be provision to control the operation in a targeted manner in order to achieve a situation whereby various apparatuses reach an end of their service life at different times. This may for example be advantageous when an individual apparatus is able to be exchanged without interrupting the operation of the whole overall device. As a result, a maximum availability and reliability of the overall device is thus then able to be achieved. In any case, by controlling the operation depending on the expected service life of at least one apparatus, a technically particularly reliable, economically improved and more environmentally friendly operation of the device is able to be achieved.

In some embodiments, the determined expected service life of the apparatus may be transmitted to a central server device. As an alternative, the expected service life may be determined by the central server device, for which purpose for example the at least one recorded value of the operating parameter is able to be transmitted to this central server device. By virtue of such central data recording and/or data management, for example by way of a cloud application or of a grid management system, particularly complex calculations, in particular for a plurality of apparatuses, may be performed economically and with minimum technical expenditure. It is thus possible to save on redundant hardware. Likewise, respective measured or sensor values of a plurality of apparatus may be used in the determination of the expected service life of an apparatus. To this end, for example, respective data of a plurality of apparatus of the same type or of the same nature may be used as data basis. By using such an expanded data basis, the expected service life may be determined particularly accurately and reliably. It is also advantageous that extensive histories consisting of a multiplicity of values of the operating parameter are able to be stored particularly easily and are able to be retrieved particularly easily and quickly.

In some embodiments, the central server device may have further functionalities. By way of example, the central server device may have an information mechanism that unburdens a respective operator in the analysis of the recorded and/or determined data, which may be advantageous in particular in the case of a multiplicity of apparatus managed by way of the central server devices. By way of example, the central server device may serve to output respective expected service lives of a multiplicity of monitored apparatus in bundled form, for example in the form of tables and/or graphics. The central server device may in each case likewise compare the determined expected service life with a predefined threshold value, which may for example be predefined specifically for an individual apparatus or for a type of the respective apparatus, for example a specific cable type.

In some embodiments, a system for determining or for the determination of an expected service life of an electrical apparatus with respect to a reference time comprises a recording device, a storage device, and a data processing device. The recording device is configured so as to record a value of at least one electrical operating parameter of the apparatus during operation of the apparatus. The storage device stores an ageing model that describes an ageing behavior of the apparatus. The data processing device is configured so as to adjust the ageing model depending on the recorded value of the operating parameter and so as to determine the expected service life of the apparatus on the basis of the adjusted ageing model.

The properties and developments of methods incorporating teachings of the present disclosure specified up to now and below, and the corresponding advantages, are respectively able to be applied, where expedient, to a system and/or components and devices used or able to be used to perform the methods, and vice versa. The teachings of the present disclosure thus also include such developments of the method and of the system that have configurations that are not explicitly described here in the respective combination.

The embodiments explained below are examples embodiments of the teachings of the present disclosure. In the exemplary embodiments, the described components of the embodiments each constitute individual features of the teachings that should be considered independently of one another, which each also develop the teachings independently of one another and should thus also be considered individually or in a combination other than that shown as a component. The described embodiments are furthermore also able to be supplemented by more of the features that have already been described. Identical, functionally identical or mutually corresponding elements are identified using the same reference signs in the figures.

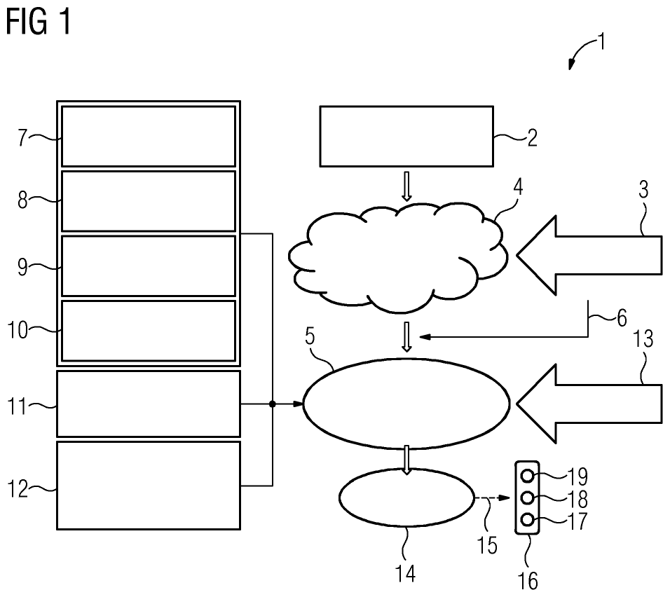

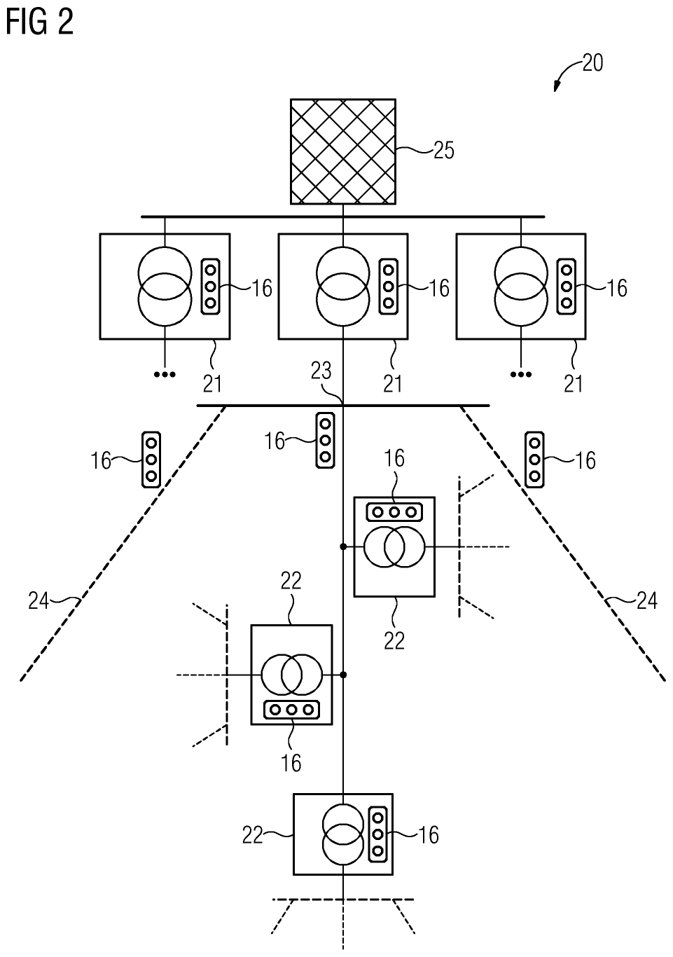

FIG. 1 schematically shows an exemplary method scheme 1 of a method for determining an expected service life of an electrical apparatus. In this case, an ageing model 2 is first of all provided that describes an ageing behavior of the apparatus. In addition, a value, which is referred to here as measured value 3, of at least one electrical operating parameter of the apparatus is recorded during operation of the apparatus. The electrical operating parameter may in particular be or comprise a current intensity and/or an electric voltage. The apparatus may for example be part of an electrical distribution grid 20 (cf. FIG. 2).

Starting from the original ageing model 2, the measured value 3 may be taken into account in order to determine or to be able to determine an adjusted change in service life 4. This change in service life 4 may thus for example be a subfunction, adjusted depending on the measured value 3, of the ageing model.

A further adjustment may be made on the basis of this change in service life 4 adjusted to the respective apparatus or the corresponding change in service life function. This may take place for example by weighting 5 the change in service life 4 or one or more subfunctions of the ageing model 2. The weighting 5 may comprise inserting and/or changing at least one weighting factor. The weighting 5 may take place for example depending on or taking into account a loading duration 6. Further influencing variables to be taken into account in the weighting 5 may be for example a reference time, such as for example a time of putting into service 7 of the apparatus, a state 8 of the apparatus, as may be determined for example by way of a diagnostic measurement, an experience value in relation for example to an actual service life of other apparatus that are similar or of the same type, a planned exchange 10 or the time thereof, a loading history 11 of the apparatus and/or further additional data 12. The loading history 11 may comprise for example measured values 3 of the operating parameter that were recorded at earlier times. The further additional data 12 may comprise for example an environmental temperature and/or a number of errors that have occurred previously on the or in connection with the apparatus. A loading forecast 13 may likewise be taken into account for the weighting 5. This loading forecast may be generated automatically for example based on the loading history 11 and/or taking into account the current measured value 3 and/or the loading duration 6. The loading history 11 may in this case comprise an average loading value. After the weighting 5, a residual remaining service life 14 of the apparatus is then able to be determined, in a particularly accurate and reliable manner, in a manner individually adjusted to the respective apparatus and its situation.

The remaining service life 14 determined in this way may be provided, for example by way of an output 15, to an operator and/or to another system, such as for example an asset management system. In the present case, a traffic light display 16 may for example be provided for this purpose, which traffic light display may comprise a first display element 17, a second display element 18 and a third display element 19. The display elements 17, 18, 19 may have for example different colors. In this case, for example, the first display element 17—for example in a green color—may display if or that the remaining service life 14 is more than ten years. The second display element 18—for example in an amber color—may display if or that the remaining service life 14 is five to ten years. The third display element 19—for example in a red color—may display if or that the remaining service life 14 is less than five years.

FIG. 2 shows a schematic and sectional illustration of an example electrical distribution grid 20, which may be for example a medium-voltage grid. In the present case, a plurality of primary transformer stations 21 are provided as parts of the electrical distribution grid 20, which transformer stations may be provided for example in order to transform a grid voltage from 110 kV to 20 kV. Downstream of these primary transformer stations 21 there are arranged a plurality of secondary transformer stations 22 of the distribution grid 20, which may be provided for example in order to transform the grid voltage from 20 kV to 0.4 kV. The electrical distribution grid 20 in this case naturally has grid nodes 23, only one of which is identified here by way of example. Furthermore, the electrical distribution grid 20 comprises a plurality of lines 24, only some of which are likewise identified here by way of example.

Both the transformer stations 21, 22 and the grid nodes 23 and the lines 24 may each be or comprise an electrical apparatus. These may be for example individual transformers in the case of the transformer stations 21, 22, for example a switching or distribution device in the case of the network nodes 23 and for example the lines 24 themselves or parts or sections thereof in the case of the lines 24. These individual apparatus are each monitored as to their expected service life. In the present case, individual traffic light displays 16 are each arranged both on the transformer stations 21, 22 and on the network nodes 23 and the lines 24, which traffic light displays display or signal a respective expected service life of the individual apparatus.

The expected service lives of the individual apparatus of the transformer stations 21, 22, of the network nodes 23 and of the lines 24 may be determined in a decentralized manner, that is to say in each case individually in situ. In this case, for example, it is possible to resort to a central device 25 that may be connected directly or indirectly to all of the electrical apparatus of the electrical distribution grid. Likewise, the individual expected service lives of the individual apparatus may be determined centrally by way of the central device 25. Corresponding results may then for example be transmitted to the individual traffic light display 16. In some embodiments, the traffic light display 16 for the individual apparatus and/or alternative signaling means may be provided on or as part of the central device 25.

The central device 25 is able to control operation of the distribution grid 20 depending on the determined expected service lives of the individual apparatus, that is thus to say of the transformer stations 21, 22, of the network nodes 23 and of the lines 24, and thus also their respective loading. What is shown and described overall is how an expected service life of an electrical apparatus is able to be determined, this being able to be performed for example in the context of what is known as a “live asset-management and maintenance planning support system” (LAMPS system) for assistive real-time asset management and maintenance planning.

What is claimed is:

1. A method for determining an expected service life of an electrical apparatus with respect to a reference time the method comprising:
providing an ageing model describing an ageing behavior of the apparatus;
recording a value of an electrical operating parameter of the apparatus during operation of the apparatus;
adjusting the ageing model based at least in part on the recorded value; and
determining the expected service life of the apparatus using the adjusted ageing model.

2. The method as claimed in claim 1, further comprising weighting a subfunction of the ageing model to adjust the ageing model.

3. The method as claimed in claim 2, wherein the subfunction is weighted based on a type of the reference time and/or on a loading history of the apparatus and/or on an environmental state and/or on a number of errors occurring on the apparatus.

4. The method as claimed in claim 1, further comprising:
providing a loading forecast of the apparatus; and
adjusting the ageing model based on the loading forecast.

5. The method as claimed in claim 1, wherein the value of the operating parameter is recorded by active management of an electrical grid into which the apparatus is incorporated and/or with a device serving for error detection purposes.

6. The method as claimed in claim 1, wherein the expected service life is determined in a recursive and self-learning process including:
automatically redefining the reference time based on a loading of the apparatus and/or on the determination of the expected service life; and/or
automatically adjusting a loading forecast of the apparatus based on previous recorded values of the operating parameter.

7. The method as claimed in claim 1, further comprising comparing the determined expected service life at a current determination time with a remaining service life derived for this determination time from at least one previous determination of the expected service life.

8. The method as claimed in claim 1, wherein the apparatus comprises an assembly of a plurality of elements;
further comprising calculating a respective expected service life for each of the elements; and
determining the expected service life of the overall apparatus as equivalent to a lowest of the expected service lives calculated for an individual element.

9. The method as claimed in claim 1, further comprising regularly adjusting the ageing model during operation of the apparatus depending on a plurality of values recorded up to a respective current time.

10. The method as claimed in claim 1, further comprising:
transmitting the determined expected service life to a control device; and
controlling operation of a device comprising the apparatus depending on the expected service life.

11. A system for determining an expected service life of an electrical apparatus with respect to a reference time, the system comprising:
a recording device for recording a value of an electrical operating parameter of the apparatus during operation of the apparatus;
a storage device storing an ageing model describing an ageing behavior of the apparatus; and
a data processing device for adjusting the ageing model depending on the recorded value of the operating parameter and for determining the expected service life of the apparatus on the basis of the adjusted ageing model.
